(19) United States
(12) Patent Application Publication
(10) Pub. No.: US 2010/0125444 A1
(43) Pub. Date: May 20, 2010

(54) Method And Apparatus For Reducing Read Latency In A Pseudo Nor Device

(76) Inventors: Siamak Arya, Cupertino, CA (US); Fong-Long Lin, Fremont, CA (US)

Correspondence Address: DLA PIPER LLP (US ), 2000 UNIVERSITY AVENUE, EAST PALO ALTO, CA, 94303-2248, US

(21) Appl. No.: 12/272,710

(22) Filed: Nov. 17, 2008

(51) Int. Cl. G06F 9/455; G06F 12/00

(52) U.S. Cl. 703/26; 711/104; 711/E12.001

(57) ABSTRACT

A NOR emulating memory device has a memory controller with a first bus for receiving a NOR command signal, and for servicing a read operation from a desired address in a NOR memory. The memory controller has a second bus for communicating with a NAND memory in a NAND memory protocol, and a third bus for communicating with a RAM memory. A NAND memory is connected to the second bus. The NAND memory has an array of memory cells divided into a plurality of pages with each page divided into a plurality of sectors, with each sector having a plurality of bits. The NAND memory further has a page buffer for storing a page of bits read from the array during the read operation of the NAND memory. A RAM memory is connected to the third bus. The memory controller has a NOR memory for storing program code for initiating the operation of the memory controller, and for receiving NOR commands from the first bus and issuing NAND protocol commands on the second bus, in response thereto, to emulate the operation of a NOR memory device. The program code causes the memory controller to read a first sector of bits from the page buffer of the NAND memory and to write the sector of bits into the RAM memory, wherein the first sector contains the location of the desired address, and supplying data from said RAM memory in response to the read operation.

### TECHNICAL FIELD

The present invention relates to a memory storage device that emulates the operation of a NOR memory device, and comprises a NAND memory device with an associated memory controller and a RAM memory device such that the memory a storage device emulates the operation of a NOR memory device with a reduction in read latency.

### BACKGROUND OF THE INVENTION

Memory storage devices that use a NAND memory with a controller and a RAM as a cache to emulate the operation of a NOR memory is well known in the art. See U.S. Patent Application publication US 2007/0147115A1, (herein after: Lin et al. Publication) whose disclosure is incorporated herein by reference in its entirety. In the Lin et al. Publication, a memory storage device (shown as 10 in FIG. 1) is described in which a NAND memory 14 is used as a non-volatile memory, with a controller 12 controlling the operation of the NAND memory 14 and a RAM memory 16. The controller 12 receives NOR type commands and operates the NAND memory 14 and the RAM memory 16 to emulate the operation of a NOR memory. Specifically, in a read operation, data from the NAND memory 14 is read from the NAND memory 14 and stored in the RAM memory 16, which acts as a cache. Further, the NAND memory 14 has an array of cells storing a plurality of bits of data. The array of NAND cells is divided into a plurality of pages, with each page storing a plurality of bits. Further, each page is divided into a plurality of sectors, with each sector having a plurality of bits. Finally, the NAND memory 14 has a page buffer for storing a page of bits. In a read operation to the NAND memory, a page of bits is read from a particular page of data from the array of NAND cells and written into the page buffer

During a read operation to the memory storage device emulating the operation of a NOR memory, there are two possibilities. The first possibility is that the data requested by the host 20 from a desired address in a NOR like memory is found in the RAM memory 16. In that event, the controller 12 responds by supplying the data from the RAM memory 16. This is the fastest read operation. In the second possibility, called a read miss, the data is not found in the RAM memory 16. Thus, the data must be first read out of the particular page in the array of NAND cells, into the page buffer within the NAND memory 14, and then into the RAM memory 16.

In the prior art, as described in the Lin et al. Publication, in a read miss operation, the data from the RAM memory 16 is not read and supplied to the host 20 until all of the data from the page buffer in the NAND memory 14 is written into the RAM memory 16. The total latency or wait time can be as long as the order of 100 usec, from the time when a read operation is received by the controller 12 from the host 20, until data is supplied by the controller 12 from the RAM memory 16 to the host 20.

In another prior art, a processor cache line is composed of 2 or 4 cache blocks of 16 or 32 bytes each in order to reduce the size of the tag RAM. The cache controller loads one cache block at a time in the event of a miss, and keeps track of empty cache block in each cache line. If an empty block in a cache line is accessed, a cache miss results. And, if a full block in a cache line is accessed, the corresponding data is transferred to the processor. In this approach, the whole cache line is not filled at the same time. Therefore, the miss latency is reduced to filling one half or one quarter of the cache line. However, such prior art does not deal with the problem of latency from accessing a NAND device emulating the operation of a NOR device.

Thus, waiting to load a full NAND page in order to receive 16 or 32 bytes of data can be very time consuming, and there is a need to reduce the latency during such read operation.

### SUMMARY OF THE INVENTION

Accordingly, in the present invention, a NOR emulating memory device comprises a memory controller having a first bus for receiving a NOR command signal, and for servicing a read operation from a desired address in a NOR memory. The memory controller has a second bus for communicating with a NAND memory, and a third bus for communicating with a RAM memory. A NAND memory is connected to the second bus. The NAND memory has an array of memory cells divided into a plurality of pages with each page divided into a plurality of sectors, with each sector having a plurality of bits. The NAND memory further has a page buffer for storing a page of bits read from the array during the read operation of the NAND memory. A RAM memory is connected to the third bus. The memory controller has a NOR memory for storing program code for Initiating the operation of the memory controller, and for receiving NOR commands from the first bus and issuing NAND commands on the second bus, in response thereto, to emulate the operation of a NOR memory device. The program code causes the memory controller to read a first sector of bits from the page buffer of the NAND memory and to write the sector of bits into the RAM memory, wherein the first sector contains the location of the desired address, and supplying data from said RAM memory in response to the read operation.

### BRIEF DESCRIPTION OF THE DRAWINGS

FIG. 1 is a block level diagram of the improved NOR emulating memory system of the present invention, having reduced read latency.

FIG. 2 is a detailed block level diagram of a portion of the embodiment shown in FIG. 1.

### DETAILED DESCRIPTION OF THE INVENTION

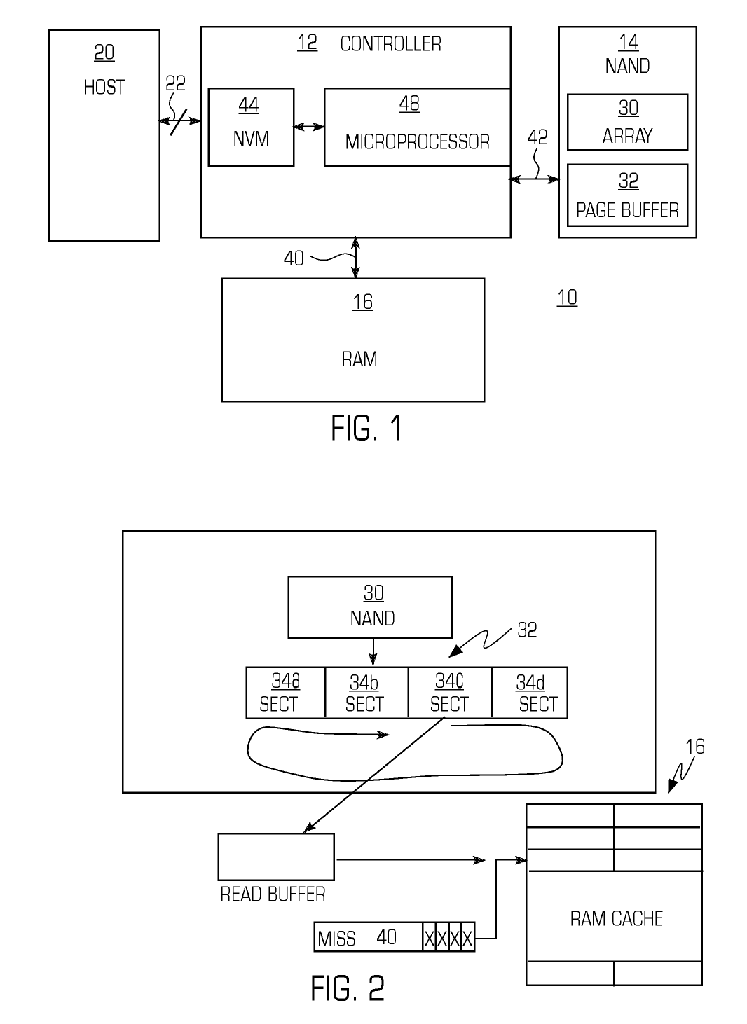

Referring to FIG. 1 there is shown a block level diagram of an improved memory storage device 10 of the present invention. As disclosed in the Lin et al. Publication (whose disclosure is incorporated herein by reference in its entirety), the device 10 comprises a controller 12. The controller 12 has a first bus 22 (which can include, address and data and control lines) which is connected to a host device 20. The host device 20 can be a computer. The host device 20 supplies NOR memory signals to the controller 12 over the first bus 22. One of the command signals that the host 20 can send to the device 10 is a read operation in accordance with a NOR command, i.e. the host 20 sends a read request from an address as if the storage device 10 were a NOR memory device.

The controller 12 has a microprocessor 48 that controls the controller 12 and the storage device 10. The microprocessor 48 executes programs that are stored in an on-board non-volatile memory 44 in the controller 12. In the preferred embodiment as disclosed in the Lin et al Publication, the NVM memory 44 is a NOR memory to store boot up code for the processor 48. In addition, the processor 48 can execute the code in place from the NVM 44. The processor 48 executes the code stored in the NVM 44 to control the storage device 10 as well as to implement the present invention of reducing latency in servicing a read request from the host 20.

The controller 12 has a second bus 42 which is connected to a NAND memory 14. The NAND memory 14 in a preferred embodiment is a separate integrated circuit die. The NAND memory 14 as is well known has an array 30 of NAND cells. The array 30 comprises a plurality of pages of memory cells. Each page of memory cell is divided into a plurality of sectors, with each sector comprising a plurality of cells storing one or more bits in each cell. The NAND memory 14 also comprises a page buffer 32. In servicing a read operation from the NAND memory 14, a page of data is read from the array 30 and is stored in the page buffer 32.

The controller 12 also has a third bus 40 connected to a RAM memory 16. The RAM memory in the preferred embodiment is a volatile memory of either SRAM or DRAM, and is directly addressable.

In the operation of the device 10, when a read operation is received from the host 20, the controller 12 checks to determine if the data at the particular address specified by the host 20 is already stored in the RAM memory 16. If it is already stored in the RAM memory 16, then data at the requested address is read from the RAM memory 16 by the controller 12 and supplied to the host 20.

In the event of a read miss, i.e. the data specified by the host 20 at the particular address is not already stored in the RAM memory 16, then the controller must first read the NAND memory 14, store the read data from the NAND memory 14 into the RAM memory 16, and then supply the data from the requested address to the host 20. All of this should be done as quickly as possible.

In the prior art, as disclosed in the Lin et al Publication, in the event of a read miss. The retrieval of the data from the RAM memory 16 to be supplied to the host 20 does not commence until the entirety of a page of data from the page buffer 32 is first stored in the RAM memory 16. Since a page of data is typically large, such as 2 KB, 4 KB or 8 KB, and the amount of data typically requested by a host in a NOR read operation is far less than that (e.g. 4, 8, 16 or 32 Bytes), the waiting time from the commencement of a read request by the host 20 until data is actually supplied by the controller 12 can be as long as 100+ usec. This can adversely affect performance.

In the device 10 of the present invention the controller 12 controls the operation of the NAND memory 14 and the RAM memory 16 to accomplish the result of reducing read latency. This is done by the programming code stored in the NVM memory 44 which is executed by the microprocessor 48. In particular, when a read request is received by the controller 12, the controller 12 determines from the hit/miss logic 68 as disclosed in the Lin et al Publication to determine if a read miss occurred. In the event a read miss occurred, the controller 12 maps the desired read address as received from the host 20 to the actual page address of the NAND memory 14 and selects the particular location in the array 30 where the page of data corresponding to the requested NOR address resides. The mapping of the desired read address to the page address is performed by the controller 14 in the CAM (Content Addressable Memory) 66, as shown in the Lin et al. Publication. The controller 12 then reads the particular page of data from the array 30 into the page buffer 32. Once the entire page of data from the array 30 is read and is stored in the page buffer 32, the controller 12 determines the boundary of the nearest sector where the desired read address is located. Thus, for example, as shown in FIG. 2, a page of data stored in the page buffer 32 may have 4 sectors (designated 34(a-d)) of data with each sector 34 containing a plurality of bits. For example, if a page as stored in the page buffer 32 contains 16 Kbits, then each sector 34 would have 4 Kbits.

The controller 12 would then commence to read the contents of the page buffer 32 from the boundary of the sector 34 that contains the requested address. For example, if the desired read address is for data stored in sector 34c, which is the third sector from the beginning of the page in the page buffer 32, the controller 12 would cause the contents of the sector 34c to be first read from the page buffer 32 and stored in the RAM memory 16. Once the sector 34c is read from the page buffer 32 and is stored in the RAM memory 16, a register 40 associated with the page buffer 32 is marked to indicate that the sector 34c has been read. Thus, the register 40 in the preferred embodiment, has as many indicators as there are sectors 34 in the page buffer 32. If there are four sectors 34 in the page buffer 32, then the register 40 has a similar number of indicators. Once the sector 34c has been read, the indicator in the register 40 corresponding to sector 34 is also marked to indicate that the sector 34c has been read from the page buffer 32.

After the data from the desired sector 34c is read and is stored in the RAM memory 16, the controller 12 begins to immediately read the particular read address from the RAM memory 16 and to service the read request from the host 20. The data is supplied to the host 20 along the first bus 22.

At the same time, or immediately thereafter, the controller 12 continues to read other sectors 34 from the page buffer 32 and store them in the RAM memory 16, until all of the remaining sectors 34 have been read from the page buffer 32 and stored in the RAM memory 16. The controller 12 reads the remaining sectors 34 in a cyclical fashion, i.e. the sector 34d following the read sector 34c is next read, then followed by the first sector 34a and then the second sector 34b. Further, as each sector 34 is read from the page buffer 32, the corresponding. indicator in the register 40 is changed to indicate that sector 34 has been read. In this manner, in the event, the microprocessor 48 is interrupted by a request to service a more urgent task, the processor 48 can resume the operation by simply referring to the indicators in the register 40 to determine which sectors 34 in the page buffer 32 remain to be read and stored in the RAM memory 16.

From the foregoing it can be seen that by reading first the sector 34 containing the desired read address from the page buffer 32 into the RAM memory 16, and then reading the desired read address from the RAM memory 16, read latency in the event of a read miss is minimized.

What is claimed is:

1. A NOR emulating memory device comprising:
a memory controller having a first bus for receiving a NOR command signal, and for servicing a read operation from a desired address in a NOR memory;
said memory controller further having a second bus for communicating with a NAND memory device, and a third bus for communicating with a RAM memory device;
a NAND memory device connected to said second bus, said NAND memory device having an array of memory cells divided into a plurality of pages with each page divided into a plurality of sectors, with each sector having a plurality of bits; and a page buffer for storing a page of bits read from the array during the read operation;
a RAM memory device connected to said third bus; and
said memory controller further having a NOR memory for storing program code for initiating the operation of said memory controller, and for receiving NOR commands from said first bus and issuing NAND commands on said second bus, in response thereto, to emulate the operation of a NOR memory device, and further for reading a first sector of bits from the page buffer of the NAND memory device and writing said sector of bits into said RAM memory device, wherein said first sector contains the location of the desired address, and supplying data from said RAM memory in response to the read operation.

2. The NOR emulating memory device of claim 1 wherein said memory controller for reading bits from sectors other than the first sector from the page buffer of the NAND memory device to the RAM memory.

3. The NOR emulating memory device of claim 2 wherein said memory controller further comprising a register for determining when there is a read miss to a particular sector of a page.

4. The NOR emulating memory device of claim 3 wherein said register comprises a plurality of indicators, with one indicator for each sector of said page.

5. A method of reducing the latency in a read operation from a desired address from a NOR memory device, wherein said read operation is performed on a NAND memory device emulating the operation of a NOR memory device, wherein said NAND memory device is characterized by an array of memory cells divided into a plurality of pages with each page divided into a plurality of sectors, with each sector having a plurality of bits, wherein said NAND memory device further having a page buffer for storing a page of bits read from the array during the read operation, said method comprising:
reading a first sector of bits from the page buffer of the NAND memory device to a RAM cache memory wherein said first sector has the location of the desired address; and
supplying bits from the RAM memory from the first sector to complete the read operation.

6. The method of claim 5 further comprising:
reading sequentially sectors of bits after the first sector from the page buffer of the NAND memory device to the RAM memory after said first sector is read.

7. The method of claim 6 further comprising:
accounting for the sectors transferred from the page buffer to the RAM memory to ensure that all sectors of bits are transferred from the page buffer to the RAM memory.
